(19) United States
(12) Patent Application Publication
(10) Pub. No.: US 2020/0187405 A1
(43) Pub. Date: Jun. 18, 2020

(54) HANDHELD PLANT CULTIVATOR

(71) Applicant: Nikki Marie Johanson, Silverdale, WA (US)

(72) Inventor: Nikki Marie Johanson, Silverdale, WA (US)

(21) Appl. No.: 16/660,685

(22) Filed: Oct. 22, 2019

Related U.S. Application Data
(60) Provisional application No. 62/748,981, filed on Oct. 22, 2018.

(51) Int. Cl. A01B 1/20; A01B 1/08; A01B 1/16

(52) U.S. Cl. CPC A01B 1/20; A01B 1/16; A01B 1/08

(57) ABSTRACT

A handheld cultivator blade generally composed of a crescent shaped blade formed of a non-permeable material such as metal with a hole cut out on each end of crescent blade; attaching at the center to a metal rod that attaches to a handle for precision handheld cultivation.

### CROSS-REFERENCE TO RELATED APPLICATIONS

| Application | Date | |
|---|---|---|
| No. | Filed | Title |
| Current | Herewith | HANDHELD PLANT CULTIVATOR |
| application | | |
| | | which claims benefit of, and priority to: |
| 62/748,981 | Oct. 22, 2018 | HANDHELD PLANT CULTIVATOR |

the entire specification of each of which is incorporated herein
by reference.

### BACKGROUND OF THE INVENTION

### Field of the Art

The disclosure relates to the field of cultivation devices, and more particularly to the field of handheld cultivation devices.

### Discussion of the State of the Art

In the field of cultivation and its devices, flowers and crops need cultivation as a means of keeping them alive. Cultivation of plants is a time-consuming endeavor that requires a great deal of labor on the cultivator's behalf. Standing in scorching heat, pouring rain, wind, and even snow with a hoe can take a toll on the body. Not all cultivation is done with a simple hoe however; most cultivation devices (or “cultivators”) are larger and bulkier which prevents them from fitting between narrow flowers beds or tightly packed crop rows. This bulkiness can also mean damage to plants as large cultivator device bodies can snap off plant limbs or damage stalks and stems. Some cultivation devices are electric or gas-powered; some plant species are sensitive to vibrations and fumes, so electric powered cultivation devices could damage plants by vibrating on the wrong frequency, or gas-powered devices could damage plants with exhaust fumes. Electric and gas-powered cultivation devices can be expensive; parts can get clogged or break down requiring cleaning or replacement by a specialist; and they are often not as easily cleaned as safety hazards are more extreme due to moving parts.

However, cultivation remains a necessary part of gardening and farming. Cultivation destroys weeds, loosens earth that has been packed down from rain or dried up with sunlight, and aerates the soil, allowing fresh air to reach the plants as well as making it easier for water to reach plant roots.

What is needed is a simple, handheld cultivator device with a blade, rod, and handle for precision manual cultivation of flowers, small gardens, and narrow rows of crops.

### SUMMARY OF THE INVENTION

Accordingly, the inventor has conceived and reduced to practice, in a preferred embodiment of the invention, a handheld cultivator device generally composed of a crescent shaped blade formed of metal and attached to a rod also formed of metal; rod and blade attach to a handle for precision handheld cultivation of flowers and crops.

The disclosed invention is a handheld plant cultivator similar to draw-hoes in design and purpose, capable of cutting weeds, digging up soil, clearing or shaping soil, digging up and grabbing weeds from underground due to the shape of the specialized blade of the invention, and modular attachment to a handle with a rigid rod assembly, and may be done while standing with little stress to a user's back, due to the shape of the implement.

According to a preferred embodiment of the invention, a handheld plant cultivator is disclosed, comprising: a rigid, non-straight rod; a rigid, curved blade; wherein the rigid, non-straight rod is attached to the rigid, curved blade; wherein the rigid blade is curved concave on a first side, and convex on a second side, the second side having two convex curves which meet in the middle; wherein the non-straight rod has at least one hole in the material; wherein the non-straight rod may be inserted into a handle using the at least one hole to fasten it into a handle; and which may be used at least to clear weeds.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is an illustration of an exemplary cultivator blade according to a preferred embodiment of the invention, illustrating blade shape.

FIG. 2 is an illustration of an exemplary handheld cultivator device according to a preferred embodiment of the invention, illustrating blade and rod assembled.

FIG. 3 is an illustration of an exemplary handheld cultivator device with a handle attached, according to a preferred embodiment of the invention.

### DETAILED DESCRIPTION

The inventor has conceived, and reduced to practice, a handheld cultivator device generally composed of a crescent shaped blade formed of metal and attached to a rod also formed of metal; rod and blade attach to a rod for handheld, precision cultivation of flowers and crops.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

### Detailed Description of Exemplary Embodiments

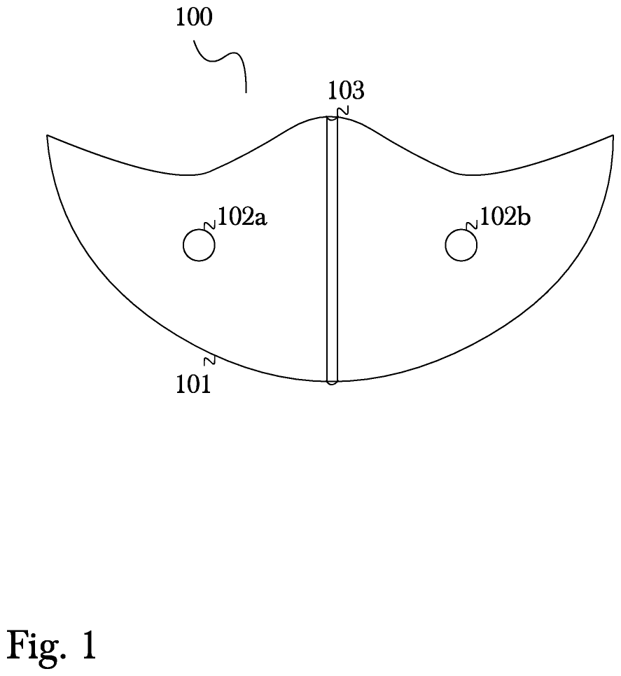

FIG. 1 is an illustration of an exemplary cultivator blade 100 according to a preferred embodiment of the invention, illustrating a blade shape. Cultivator blade 100 is generally composed of a crescent 101 shape formed of a non-permeable material such as metal (it should be appreciated that other shapes may be used such as an alternating crescent shape; where one point of the crescent is curved towards one direction and the other point is curved in the opposite direction, or other shapes according to a desired use case) with a hole 102a, 102b cut out on each end of crescent 101 shape. Crescent 101 shape is sharpened on all edges so all edges may be used for cultivation. Crescent 101 shape's widest point is center 103 being 1.25-inches wide, so cultivator blade 100 can easily cultivate plants in narrow beds, crops that are closely planted together, or for cultivating small gardens, without causing harm to the plants themselves. Such a blade 100 may be used for shaping soil, clearing soil, digging up weeds, or some combination of these, as well as other common gardening soil-working and planting needs, when attached to a rod or handle for use. The blade may be made of one of many possible materials and made to one of many possible measurements, wherein one end of the blade is a concave shape, and the opposing end is two convex curves which meet in the middle, as shown (or wherein an alternating crescent shape as described above is used).

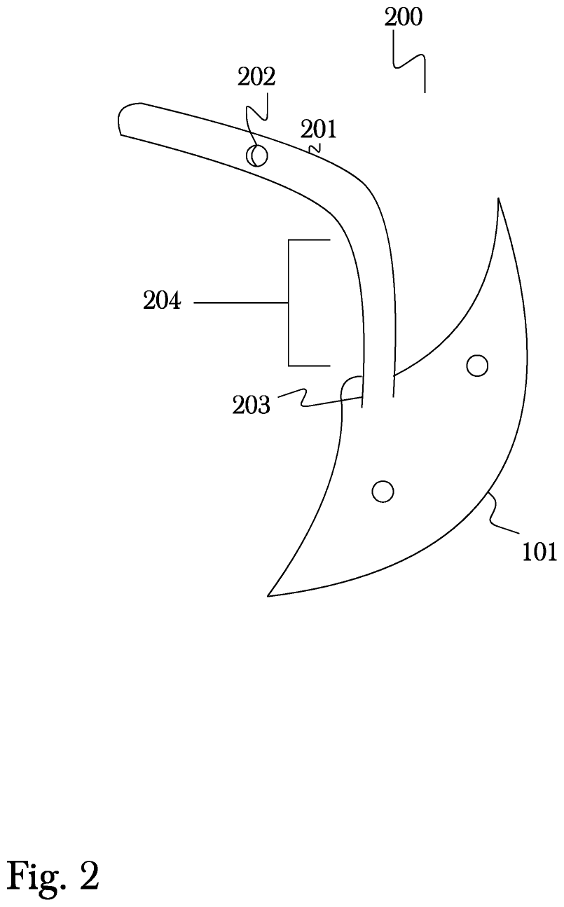

FIG. 2 is an illustration of an exemplary handheld cultivator device 200 according to a preferred embodiment of the invention, illustrating blade and rod assembled 200. Crescent 101 blade permanently connects to rod 201 at center 203 by weld or by forming both rod 201 and crescent 101 blade as one piece (it should be appreciated that rod and blade could be attached as non-permanent pieces or attached in some other fashion according to a desired use case). Rod 201 may be formed of the same non-permeable material, such as metal, as crescent 101 blade. According to a preferred embodiment, stainless or another strong steel may be used to provide strength, rigidity, and corrosion resistance (keeping in mind the typically wet and physically rough environment in which device 200 is used according to preferred embodiments). Rod 201 rises from crescent blade 101 at a first angle, which according to an embodiment is approximately 80°, and then is bent at a second angle 204 (typically about 50° from the plane of the blade) for precision cultivation when rod 201 and blade 101 are in use. An upper end of rod 201 contains a cut out hole 202 for attachment to a handle (not shown); according to an aspect the handle may be made of a durable, lightweight material such as wood or fiberglass and allows user to cultivate flowers and crops by hand and with precision, while standing. Angles of the crescent blade 101 and the bend in the blade 204 may be one of many options, for instance a 70-degree angle for the rod 201 rise from the blade 101, or a 40°, or 60°, angle of the blade's bend 204. Specified angles are for purposes of ease of illustration but are not limiting, as differences in the angles may be present in individual items or in design, as is normal for hoes and similar tools to have slight variations in angular design.

A blade 101, and a rod 201, may be made with the same material such as a metal, or may be made of different materials including different metals, wood and metal, plastics, some combination of those, or something altogether different that may perform well enough to be used. A rod 201, blade 101, and center 203 may be one solid piece such as from metal casting, or may be separate pieces welded together, or may be fastened, for example with rivets or screws. Possible materials that may be used for a blade, rod, center, any fasteners and other pieces may be any combination of any metal, any wood, any plastic, any synthetic or ceramic or glass material, or any other material that may be used in gardening tools. A blade 101 may be sharpened on either front or back, or both, or it may be blunted or not very well-sharpened. If any piece of the device is made of metal, they may be made through any of, or any combination of, cold-hammer forging, casting, milling, or any other available method of shaping metal. Such a device as a blade and rod assembly 200, especially but not solely when attached with a handle to the rod, may be used to cut weeds close to the ground by aligning the blade with the ground, or may be used to dig into the ground, for example at a 45 degree angle or similar, or may be used at a far steeper angle to reach deeper into dirt. The shape of the shown blade 100 especially is capable of being used to dig and then pull up weeds when used as a draw-hoe assembly.

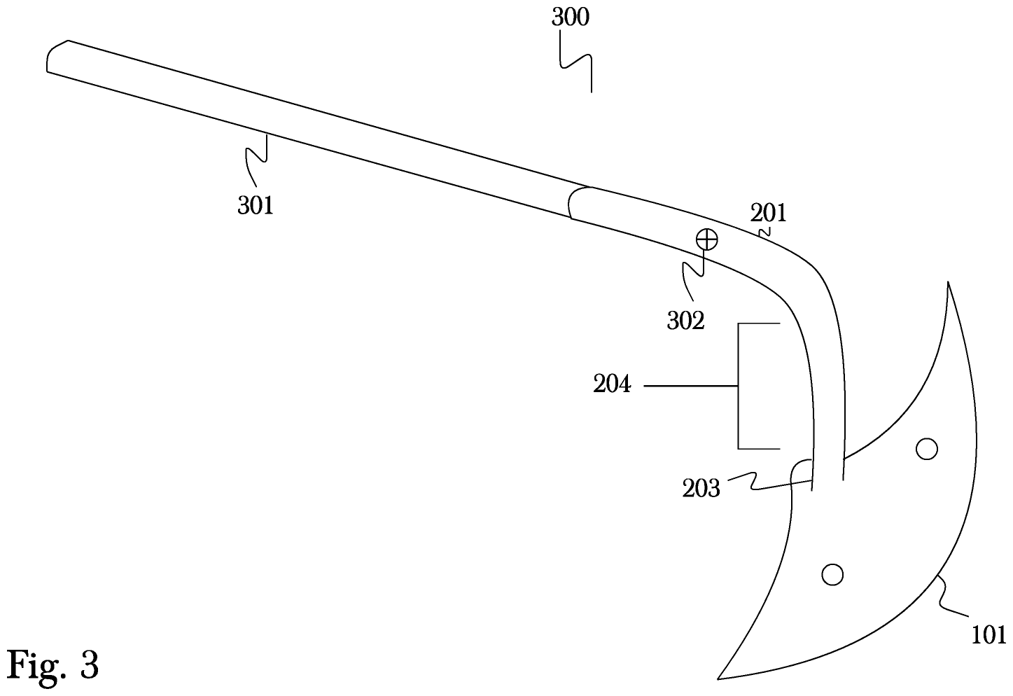

FIG. 3 is an illustration of an exemplary handheld cultivator device with a handle attached 300, according to a preferred embodiment of the invention. A shown curved blade 101 is attached at a center 203 to a bent rod 201, 204, with a handle 301 which may be either inserted or which may have the rod inserted into it, using the hole in the rod as a point at which to affix the handle 302 such as by rivet, screw, nail, peg, adhesive filling, spring-loaded mechanism, or some other method of affixing a handle to the rod. A handle 301 may be of many possible lengths, with no specified minimum or maximum in theory, and method of affixing such a handle 301 may encompass methods other than utilizing the hole in the rod 302, such as merely attaching a handle through the friction of the rod 201 and handle 301, keeping the handle steady. Materials that may be utilized in the construction of such a handle 301 include but are not limited to, any sort of metal or metal alloy such as steel, iron, titanium, or aluminum, any sort of wood, any other fibrous material, any synthetic material such as plastics or resin, fiberglass or other similar materials, rubber whether hardened or unhardened, or any combination or proportion of these materials. Materials that may be utilized in the construction of a possible affixing piece or filling or mechanism 302 may be constructed similarly or differently from a handle 301, and all pieces of the device including blade 101, rod 201, possible affixing component 302, and handle 301, may be comprised of similar materials to any one of another of them, or may all be different materials, including the use of metal or metal alloys, wood, fiberglass, synthetic materials, plastics, resin, rubber, other fibrous materials, or any other material suitable for construction of a plant cultivation tool. It is possible a handle 301 and a rod 201 are one singular piece of material, and not two separate pieces that must be inserted or affixed to one another, and it is similarly possible that all three of the handle 301, rod 201, and blade 101 are one singular piece and not merely affixed to one another but are in fact one single piece of material, possible through casting processes, sintering, welding, or similar. The purpose of such a device includes precision cultivation including soil movement, soil shaping, and weed digging, and may be done while standing with little stress to a user's back, due to the shape of the implement.

The skilled person will be aware of a range of possible modifications of the various embodiments described above. Accordingly, the present invention is defined by the claims and their equivalents.

What is claimed is:

1. A handheld plant cultivator, comprising:
a rigid, non-straight rod;
a rigid, curved blade;
wherein the rigid, non-straight rod is attached to the rigid, curved blade;
wherein the rigid blade is curved concave on a first side, and convex on a second side, the second side having two convex curves which meet in the middle;
wherein the non-straight rod has at least one hole in the material;
wherein the non-straight rod may be inserted into a handle using the at least one hole to fasten it into a handle; and
which may be used at least to clear weeds.

2. The device of claim 1, wherein the handheld plant cultivator is further used to clear and shape soil.

3. The device of claim 1, wherein the material for the rigid, non-straight rod and the rigid, curved blade are identical.

4. The device of claim 1, wherein the material for the rigid, non-straight rod and the rigid, curved blade are non-identical.

5. The device of claim 1, wherein the rigid, non-straight rod and the rigid, curved blade are a singular object, rather than two separate objects fastened together.
